(19) United States
(12) Patent Application Publication
(10) Pub. No.: US 2013/0191308 A1
(43) Pub. Date: Jul. 25, 2013

(54) METHODS AND SYSTEMS FOR PROVIDING QUALIFIED DIVIDEND INCOME UNITS

(71) Applicant: Barclays Capital Inc., New York, NY (US)

(72) Inventor: Anthony J. Tuths, Short Hills, NJ (US)

(73) Assignee: BARCLAYS CAPITAL INC., New York, NY (US)

(21) Appl. No.: 13/750,465

(22) Filed: Jan. 25, 2013

Related U.S. Application Data
(63) Continuation of application No. 12/204,625, filed on Sep. 4, 2008, now abandoned.
(60) Provisional application No. 60/969,779, filed on Sep. 4, 2007.

(51) Int. Cl. G06Q 40/06

(52) U.S. Cl. CPC G06Q 40/06
USPC 705/36 R

(57) ABSTRACT

In at least one aspect, the invention comprises a computer-implemented method comprising: (1) receiving investment amounts for a first class of partnership units with a senior position, with a second class having a subordinate position, wherein either: (a) options on an underlying security are bought and/or sold into the partnership, or (b) the first class of partnership units has an embedded short option on an underlying security, and the second class has an embedded long option; and (2) paying coupon payments on the first class for a specified period of time, wherein the coupon payments comprise dividend payments received on shares of a dividend-paying portfolio, wherein the second class absorbs losses in the portfolio up to a first specified amount, and wherein the first class absorbs losses above the first specified amount. Other aspects of the invention comprise related structure, software, and system implementations.

### CROSS REFERENCE TO RELATED APPLICATIONS

This application is a continuation of U.S. patent application Ser. No. 12/204,625, filed Sep. 4, 2008, which claims priority to U.S. Provisional Patent Application No. 60/969,779, filed Sep. 4, 2008. The entire contents of that provisional application are incorporated herein by reference.

### INTRODUCTION

An embedded option is one that is a part of another instrument or security. In contrast, a normal (or bare) option trades separately from the underlying security. An embedded option does not trade by itself, but typically does affect the value of the security of which it forms a part.

With respect to callable corporate bonds, an issuer's option to redeem the bonds before their scheduled maturity constitutes an embedded call option. An investor in such bonds has a short position in the call option, and the issuer has a long position in the call option.

An embedded option does not trade by itself, but typically does affect the value of the security of which it forms a part. For example, the value of a bond that is redeemable at the option of the issuer has an embedded short position in a call option. The holder has effectively written a call option to the issuer. The value of the bond is the value of an equivalent bond that cannot be redeemed early, less the value of a call option over the bond.

A reverse convertible security is a short-term note linked to an underlying stock. The security offers steady stream of income due to the payment of a high coupon rate. At maturity, the investor will receive either 100% of his original investment amount or a predetermined number of shares of the underlying stock, in addition to the stated coupon payment.

At maturity, there are 2 possible outcomes: cash delivery or physical delivery. Cash delivery occurs when the underlying stock closes at or above an “initial share price” on a valuation date, regardless of whether the stock closed below a “knock-in level” (typically 70-80% of an initial reference price) during the holding period. Alternatively, cash delivery may occur if the stock closes below the initial share price, but has never closed below the knock-in level.

Physical delivery occurs if the underlying shares closed below the knock-in level at any time during the holding period and does not trade above the initial share price on the valuation date (typically 4 days prior to maturity).

For tax purposes, reverse convertible notes are treated as having two components: a debt portion, and a put option. At maturity, the option component is taxed as a short-term capital gain if the investor receives cash delivery. In the case of physical delivery, the option component will reduce the tax basis of the reference shares delivered to the investor.

The Qualified Dividend Income (“QDI”) units of an embodiment of the present invention share advantages of reverse convertibles, and to an investor appear similar, but lack certain disadvantages of reverse convertibles, as explained below.

One goal of an embodiment of the invention is to mimic (for the most part) the economics of structured notes with a partnership, thereby causing coupon payments on a note to constitute qualified dividend income rather than ordinary income. Although reverse convertible notes are discussed herein, the invention is also applicable to structured notes in general.

The options embedded within normal structured notes can be embedded within the partnership interests or can be physical options that the partnership buys or sells (the partnership would need to sell an option to mimic a reverse convertible note, for example). In an embodiment, the entity forming the partnership (typically, but not necessarily, a bank) does not invest in the partnership but instead another (likely unrelated) investor buys the subordinated partnership units.

In one aspect, the invention comprises a computer-implemented method comprising: (1) receiving one or more first investment amounts from one or more investors into a partnership for a a first class of one or more partnership units in the partnership having the first class of one or more partnership units with a senior position in a capital structure of the partnership with respect to partnership capital and a second class of one or more partnership units with a subordinated position in the capital structure of the partnership with respect to partnership capital, wherein either: (a) one or more options on at least one underlying security are bought and/or sold into the partnership, or (b) the first class of one or more partnership units has an embedded short option on at least one underlying security, and the second class of one or more partnership units has an embedded long option on at least one underlying security; and (2) paying one or more coupon payments on the first class of one or more partnership units to the one or more investors for a specified period of time, wherein the one or more coupon payments comprise at least a portion of one or more dividend payments received on one or more shares of a dividend-paying portfolio purchased into the partnership, wherein the second class of one or more partnership units absorbs losses in the dividend-paying portfolio up to a first specified amount, and wherein the first class of one or more partnership units absorbs losses in the dividend-paying portfolio above the first specified amount.

In various embodiments: (A) the method further comprises receiving one or more second investment amounts into the partnership for the second class of one or more partnership units; (B) the first specified amount is a percentage based on a ratio of the one or more second investment amounts to the one or more first investment amounts; (C) the one or more second investment amounts is at least as large as the one or more first investment amounts; (D) one or more shares of the dividend-paying portfolio are purchased into the partnership in an amount equal to a sum of the one or more first and the one or more second investment amounts; (E) the one or more coupon payments comprise 100% of the one or more dividend payments; (F) the second class of one or more partnership units receives the one or more dividend payments after the one or more coupon payments have been paid in full; (G) the second class of one or more partnership units receives gains in the dividend-paying portfolio up to a second specified amount; (H) the first class of one or more partnership units receives at least a portion of gains in the dividend-paying portfolio above a second specified amount; (I) the first class of one or more partnership units absorbs all losses in the underlying security; (J) the second class of one or more partnership units absorbs no losses in the underlying security; and (K) the one or more coupon payments are treated as qualified dividend income.

In another aspect, the invention comprises a partnership structure comprising: (1) a partnership; (2) a first class of one or more partnership units with a senior position in a capital structure of the partnership with respect to partnership capital, the first class of one or more partnership units being purchased with one or more first investment amounts received from one or more investors; and (3) a second class of one or more partnership units with a subordinated position in the capital structure of the partnership with respect to partnership capital, wherein either: (a) one or more options on at least one underlying security are bought and/or sold into the partnership, or (b) the first class of one or more partnership units has an embedded short option on at least one underlying security, and the second class of one or more partnership units has an embedded long option on at least one underlying security; and wherein one or more coupon payments on the first class of one or more partnership units are paid to the one or more investors for a specified period of time, wherein the one or more coupon payments comprise at least a portion of one or more dividend payments received on one or more shares of a dividend-paying portfolio purchased into the partnership, wherein the second class of one or more partnership units absorbs losses in the dividend-paying portfolio up to a first specified amount, and wherein the first class of one or more partnership units absorbs losses in the dividend-paying portfolio above the first specified amount.

In various other embodiments: (A) the second class of one or more partnership units is purchased with one or more second investment amounts; (B) the first specified amount is a percentage based on a ratio of the one or more second investment amounts to the one or more first investment amounts; (C) the one or more second investment amounts is at least as large as the one or more first investment amounts; (D) one or more shares of the dividend-paying portfolio are purchased into the partnership in an amount equal to a sum of the one or more first and the one or more second investment amounts; (E) the one or more coupon payments comprise 100% of the one or more dividend payments; (F) the second class of one or more partnership units receives the one or more dividend payments after the one or more coupon payments have been paid in full; (G) the second class of one or more partnership units receives gains in the dividend-paying portfolio up to a second specified amount; (H) the first class of one or more partnership units receives at least a portion of gains in the dividend-paying portfolio above a second specified amount; (I) the first class of one or more partnership units absorbs all losses in the underlying security; (J) the second class of one or more partnership units absorbs no losses in the underlying security; (K) the one or more coupon payments are treated as qualified dividend income.

### BRIEF DESCRIPTION OF THE DRAWINGS

FIG. 1 depicts steps and components of a first exemplary embodiment.

FIG. 2 depicts an exemplary payoff profile of an embodiment.

FIG. 3 depicts steps and components of a second exemplary embodiment.

FIG. 4 depicts trade setup of the second exemplary embodiment.

FIG. 5 depicts a computer based system for processing data according to an embodiment of the invention.

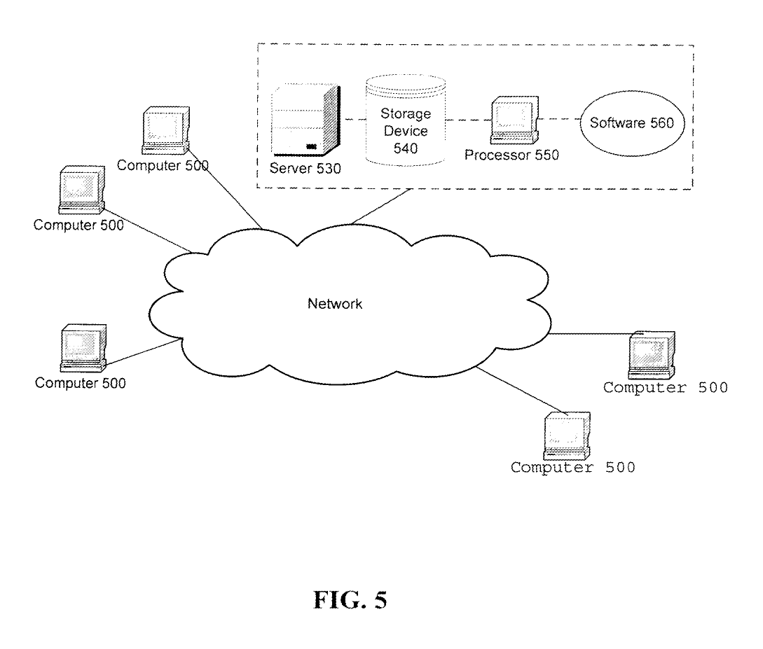

### DETAILED DESCRIPTION

Embodiments of the present invention are described in detail below.

The Qualified Dividend Income (QDI) unit is designed to offer current yield to an investor in exchange for the investor taking exposure to a certain equity or equities. A QDI unit of an embodiment is structured through a dual class partnership between an investor and a guarantor (e.g., a bank).

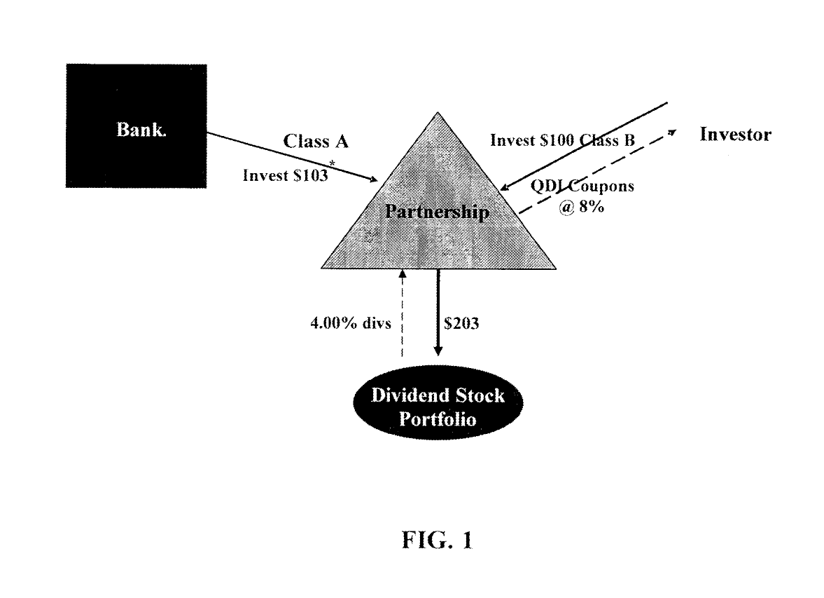

The partnership units have an embedded short option (Class B—QDI unit) and embedded long option (class A—owned by guarantor) with respect to an equity (the underlying security) not owned by the partnership. The stock portfolio owned by the partnership acts to fund the coupon to investors. See FIG. 1. Note that the guarantor's investment may take the form of equity and/or a margin loan.

The QDI unit is designed to allow income focused clients to sell volatility with respect to a certain equity or group of equities in return for an income stream. The income stream takes the form of coupons paid from the partnership on the Class B units (that is, the QDI units).

The income flowing from the partnership is, in form, qualified dividend income eligible for a 15% federal income tax rate (as opposed to the normal 35% tax rate for interest income).

To the investor, the economics of the QDI unit appear to be similar to so-called reverse exchangeable notes. The investor pays an upfront amount in exchange for a financial instrument that (i) pays a current cash coupon for a stated period of time; (ii) exposes the investor to the downside of a particular equity (or equities); and (iii) provides the investor some limited exposure to the upside the same equity (or equities).

However, unlike a reverse convertible instrument, the coupon income on the QDI unit is subject to tax at a reduced 15% federal tax rate.

The QDI unit also is similar to reverse convertible securities that offer a buy-write investment payoff The investor sells the upside appreciation (like selling a call option) in exchange for a periodic coupon (like receiving a premium for selling a call option).

The result is a note-like instrument (which may be rated if desired—typically with the rating of the guarantor) that provides an investor with above market current income and exposure to the performance of an unrelated company's common stock (the “Underlying Stock”).

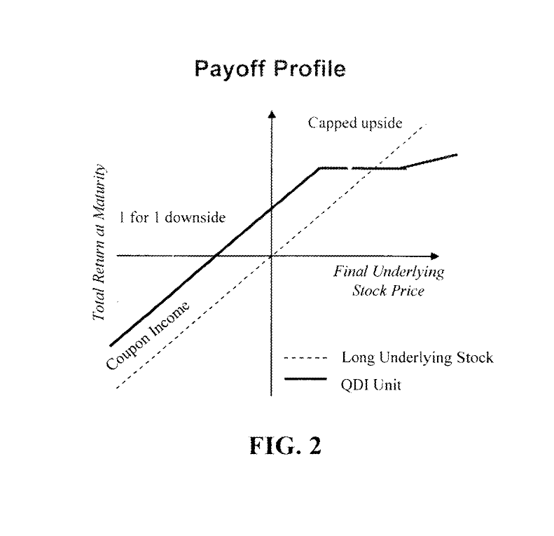

QDI units are constructed by packaging a written out-of-the-money call option with a synthetic long equity position, effectively, a “buy-write” strategy. QDI units are typically linked to a single underlying stock. QDI units offer a capped upside return profile that is flat beyond the cap price but participates at a reduced rate beyond a higher cap price. See the payoff profile depicted in FIG. 2.

The coupon income is funded by dividends on stock held by the partnership—stocks unrelated to the underlying stock.

Reverse convertibles put the investor in the economic position of being short an at-the-money put option and long a call spread with respect to the chosen equity (or, more simply, short an in-the-money put option). These same economics are present in the QDI unit.

The economic performance of the partnership may, at the investor's option, be guaranteed by the guarantor and thereby permit the QDI unit to be rated.

Rather than the security's coupon being funded by the implied option premium, here a partnership between the guarantor and the investor acquires a basket of high-dividend-paying equities wherein the dividends fund the coupon on the security.

Thus, in contrast to reverse convertible economics, the investor is also exposed to the downside potential of the long stock portfolio but only beyond the amount of the guarantor's capital in the partnership (i.e., the guarantor takes the first loss, thereby providing a significant level of protection to the investor).

In exchange for this additional downside risk, the investor: (i) receives a coupon that is eligible for a reduced 15% rate of federal taxation, and (ii) is able to participate in 10% of any gains in the long stock portfolio beyond the first 20%.

### EXAMPLE

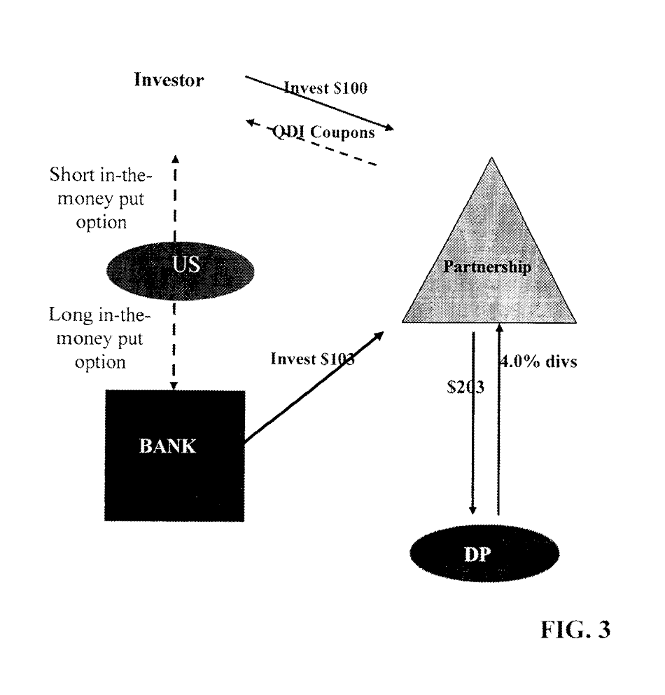

See FIG. 3. Assume DP pays a 4% dividend yield. Assume investor wants exposure to US (0% dividend yield), the “Underlying Stock.”

Investor buys the QDI unit for $100.

Guarantor buys the Class A Units for $103 (or a lesser amount and the partnership incurs a margin debit). Partnership purchases $203 of DP (stock in dividend-paying portfolio).

The terms of the partnership units contain the economics of an embedded sale of an in-the-money put option on US from the investor to the guarantor. The dividends pass through the partnership to the investor as qualified dividend income.

Partnership structure of an embodiment is described below.

The partnership, in an embodiment, is a newly organized Delaware LLC. The partnership issues two classes of interest, Class A and Class B. See Table 1 below.

TABLE 1

| Class A—Guarantor Interest | Class B—Investor Interest |
|---|---|
| Subordinate class | Senior class |
| Losses | Losses |
| Dividend paying stock: absorbs | Dividend paying stock: absorbs |
| losses up to 50.74% | losses beyond 50.74% |
| Underlying Stock: does not | depreciation |
| participate in losses | Underlying Stock: absorbs entire loss |
| Gains | Gains |
| Dividend paying stock: 100% up to | Dividend paying stock: 10% beyond |
| 20% gain | 20% share gain |
| Underlying Stock: participates in | Underlying Stock: participates up to |
| gains above put strike | strike price |
| Income | Income |
| Dividend paying stock: 100% after | Dividend paying stock: 100% of |
| Class B coupon paid in full | income |
| Underlying Stock: N/A | Underlying Stock: N/A |

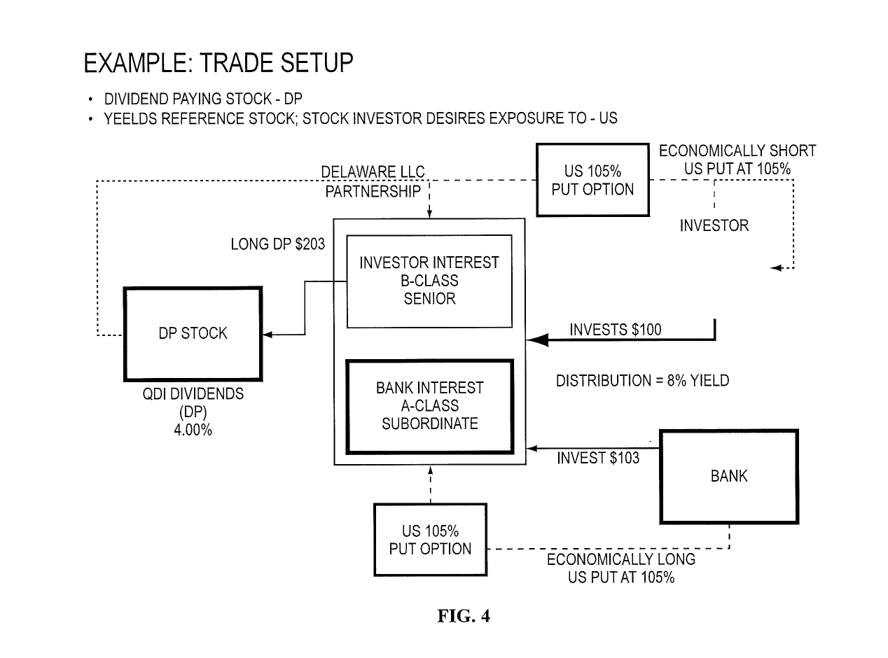

Trade setup of an embodiment is depicted in FIG. 4.

Other components and combinations of components may also be used to support processing data or other calculations described herein as will be evident to those skilled in the art. Server 530 may facilitate communication of data from a storage device 540 to and from processor 550, and communications to computers 500. Processor 550 may optionally include local or networked storage (not shown) which may be used to store temporary information. Software 560 can be installed locally at a computer 500, processor 550 and/or centrally supported for facilitating calculations and applications.

For ease of exposition, not every step or element of the present invention is described herein as part of a computer system and/or software, but those skilled in the art will recognize that each step or element may have (and typically will have) a corresponding computer system or software component. Such computer system and/or software components are therefore enabled by describing their corresponding steps or elements (that is, their functionality), and are within the scope of the present invention.

Moreover, where a computer system is described or claimed as having a processor for performing a particular function, it will be understood by those skilled in the art that such usage should not be interpreted to exclude systems where a single processor, for example, performs some or all of the tasks delegated to the various processors. That is, any combination of, or all of, the processors specified in the claims could be the same processor. All such combinations are within the scope of the invention.

The present invention has been described by way of example only, and the invention is not limited by the specific embodiments described herein. As will be recognized by those skilled in the art, improvements and modifications may be made to the invention and the illustrative embodiments described herein without departing from the scope or spirit of the invention.

1. A computer readable medium having stored thereon computer executable instructions that, when executed on a computer, configure the computer to perform a method comprising:
receiving one or more first investment amounts from one or more investors into a partnership for a first class of one or more partnership units in said partnership, wherein said first class of one or more partnership units are senior in a capital structure of said partnership with respect to partnership capital to a second class of one or more partnership units with a subordinated position in said capital structure of said partnership with respect to partnership capital,
wherein either:
(a) one or more options on at least one underlying security are bought and/or sold into said partnership, or
(b) said first class of one or more partnership units has an embedded short option on at least one underlying security, and said second class of one or more partnership units has an embedded long option on at least one underlying security; and
paying one or more coupon payments on said first class of one or more partnership units to said one or more investors for a specified period of time,
wherein said one or more coupon payments comprise at least a portion of one or more dividend payments received on one or more shares of a dividend-paying portfolio purchased into said partnership,
wherein said second class of one or more partnership units absorbs losses in said dividend-paying portfolio up to a first specified amount, and
wherein said first class of one or more partnership units absorbs losses in said dividend-paying portfolio above said first specified amount.

2. The computer readable medium of claim 1, further comprising receiving one or more second investment amounts into said partnership for said second class of one or more partnership units.

3. The computer readable medium of claim 2, wherein said first specified amount is a percentage based on a ratio of said one or more second investment amounts to said one or more first investment amounts.

4. The computer readable medium of claim 2, wherein said one or more second investment amounts is at least as large as said one or more first investment amounts.

5. The computer readable medium of claim 2, wherein one or more shares of said dividend-paying portfolio are purchased into said partnership in an amount equal to a sum of said one or more first and said one or more second investment amounts.

6. The computer readable medium of claim 1, wherein said one or more coupon payments comprise 100% of said one or more dividend payments.

7. The computer readable medium of claim 1, wherein said second class of one or more partnership units receives said one or more dividend payments after said one or more coupon payments have been paid in full.

8. The computer readable medium of claim 1, wherein said second class of one or more partnership units receives gains in said dividend-paying portfolio up to a second specified amount.

9. The computer readable medium of claim 1, wherein said first class of one or more partnership units receives at least a portion of gains in said dividend-paying portfolio above a second specified amount.

10. The computer readable medium of claim 1, wherein said first class of one or more partnership units absorbs all losses in said dividend-paying portfolio.

11. The computer readable medium of claim 1, wherein said second class of one or more partnership units absorbs no losses in said dividend-paying portfolio.

12. The computer readable medium of claim 1 wherein said one or more coupon payments are treated as qualified dividend income.

13. A system comprising:
memory operable to store at least one program;
at least one processor communicatively coupled to the memory, in which the at least one program, when executed by the at least one processor, causes the at least one processor to access and process data regarding:
a partnership;
a first class of one or more partnership units with a senior position in a capital structure of said partnership with respect to partnership capital, said first class of one or more partnership units being purchased with one or more first investment amounts received from one or more investors; and
a second class of one or more partnership units with a subordinated position in said capital structure of said partnership with respect to partnership capital,
wherein either:
(a) one or more options on at least one underlying security are bought and/or sold into said partnership, or
(b) said first class of one or more partnership units has an embedded short option on at least one underlying security, and said second class of one or more partnership units has an embedded long option on at least one underlying security; and
wherein one or more coupon payments on said first class of one or more partnership units are paid to said one or more investors for a specified period of time,
wherein said one or more coupon payments comprise at least a portion of one or more dividend payments received on one or more shares of a dividend-paying portfolio purchased into said partnership,
wherein said second class of one or more partnership units absorbs losses in said dividend-paying portfolio up to a first specified amount, and
wherein said first class of one or more partnership units absorbs losses in said dividend-paying portfolio above said first specified amount.

14. The system of claim 13, wherein said second class of one or more partnership units is purchased with one or more second investment amounts.

15. The system of claim 14, wherein said first specified amount is a percentage based on a ratio of said one or more second investment amounts to said one or more first investment amounts.

16. The system of claim 14, wherein said one or more second investment amounts is at least as large as said one or more first investment amounts.

17. The system of claim 14, wherein one or more shares of said dividend-paying portfolio are purchased into said partnership in an amount equal to a sum of said one or more first and said one or more second investment amounts.

18. The system of claim 13, wherein said one or more coupon payments comprise 100% of said one or more dividend payments.

19. The system of claim 13, wherein said second class of one or more partnership units receives said one or more dividend payments after said one or more coupon payments have been paid in full.

20. The system of claim 13, wherein said second class of one or more partnership units receives gains in said dividend-paying portfolio up to a second specified amount.

21. The system of claim 13, wherein said first class of one or more partnership units receives at least a portion of gains in said dividend-paying portfolio above a second specified amount.

22. The system of claim 13, wherein said first class of one or more partnership units absorbs all losses in said dividend-paying portfolio.

23. The system of claim 13, wherein said second class of one or more partnership units absorbs no losses in said dividend-paying portfolio.

24. The system of claim 13, wherein said one or more coupon payments are treated as qualified dividend income.
